(19) United States
(12) Patent Application Publication
(10) Pub. No.: US 2016/0335028 A1
(43) Pub. Date: Nov. 17, 2016

(54) METHOD AND APPARATUS FOR PROCESSING DATA BY USING MEMORY

(71) Applicant: SAMSUNG ELECTRONICS CO., LTD., Suwon-si (KR)

(72) Inventors: Mookyoung CHUNG, Hwaseong-si (KR); Soojung RYU, Hwaseong-si (KR); Youngsam SHIN, Hwaseong-si (KR); Wonjong LEE, Seoul (KR)

(73) Assignee: Samsung Electronics Co., Ltd., Suwon-si (KR)

(21) Appl. No.: 15/112,780

(22) PCT Filed: Jul. 18, 2014
(86) PCT No.: PCT/KR2014/006533

§ 371 Date: Jul. 20, 2016

(30) Foreign Application Priority Data
Jan. 20, 2014 (KR) 10-2014-0006731

(51) Int. Cl. G06F 3/06; G06F 12/0855

(52) U.S. Cl. CPC G06F 3/0659; G06F 3/0611; G06F 3/0613; G06F 3/0679; G06F 12/0855; G06T 1/20

(57) ABSTRACT

Provided is a data processing apparatus including: a pipeline including a plurality of stages; and a memory that stores data that is processed in the pipeline.

### TECHNICAL FIELD

The present disclosure relates to pipelines in which there are stages that each independently performs calculation.

### BACKGROUND ART

A pipeline refers to an apparatus including a plurality of stages, each of which independently performing calculation. Also, a pipeline refers to a technique of independently performing calculation. The stages of a pipeline receive data for calculation and output a calculation result of input data.

3D rendering is image processing whereby 3D object data is synthesized to form an image viewed from a given view point of a camera. Ray tracing refers to a process of tracing a point where scene objects, which are rendering objects, and a ray intersect. Ray tracing includes traversal of an acceleration structure and an intersection test between a ray and a primitive. Ray tracing may also be performed by using a pipeline.

### DISCLOSURE OF INVENTION

### Solution to Problem

Provided are methods and apparatuses for processing data by using a memory.

Provided are computer readable recording media having embodied thereon a program for executing the methods.

Additional aspects will be set forth in part in the description which follows and, in part, will be apparent from the description, or may be learned by practice of the presented embodiments.

### Advantageous Effects of Invention

As described above, according to the one or more of the above embodiments of the present invention, data used in a pipeline may be managed by using a memory.

Also, ray data may be stored in a memory, and the ray data may be read or written by using a memory address or an ID of a ray.

### BRIEF DESCRIPTION OF DRAWINGS

FIG. 1 is a view for explaining a data processing apparatus according to an embodiment of the present invention;

FIG. 2 is a detailed view illustrating the data processing apparatus of FIG. 1 according to an embodiment of the present invention;

FIG. 3 is a view for explaining a ray tracing core according to an embodiment of the present invention;

FIG. 4 is a view for explaining a data processing apparatus according to an embodiment of the present invention;

FIG. 5 is a view for explaining a ray tracing core according to an embodiment of the present invention;

FIG. 6 is a flowchart illustrating a data processing method according to an embodiment of the present invention;

FIG. 7 is a flowchart illustrating a data processing method according to another embodiment of the present invention;

FIG. 8 is a flowchart illustrating a data processing method according to another embodiment of the present invention; and

FIG. 9 is a flowchart illustrating a data processing method according to another embodiment of the present invention.

### BEST MODE FOR CARRYING OUT THE INVENTION

According to an aspect of the present invention, a data processing apparatus includes: a pipeline including a plurality of stages; and a memory that stores data that is processed in the pipeline.

According to another aspect of the present invention, a data processing method performed by using a pipeline including a plurality of stages, the data processing method includes: storing data processed in the pipeline, in a memory; and processing data by using the data stored in the memory.

### MODE FOR THE INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

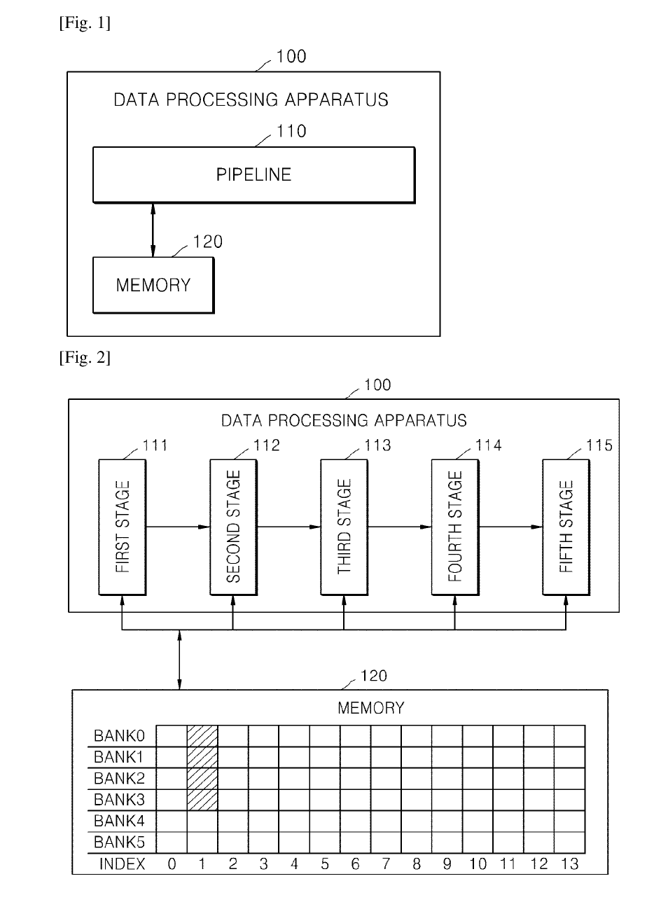

FIG. 1 is a view for explaining a data processing apparatus 100 according to an embodiment of the present invention. Referring to FIG. 1, the data processing apparatus 100 includes a pipeline 110 and a memory 120. The data processing apparatus 100 manages data used in the pipeline 110 by using the memory 120.

For example, the data processing apparatus 100 may be a graphic processing unit or a ray tracing core.

The pipeline 110 includes a plurality of stages. The plurality of stages each independently performs calculation. That is, different stages perform different calculations from one another. The stages receive data for calculation, and output data indicating a result of the calculation. The stages read data from the memory 120 or store data in the memory 120. The stages perform data processing by using data stored in the memory 120. Information about which data stored in which portion of the memory 120 is used by the stages may be set in advance.

The memory 120 stores data that is processed in the pipeline 110. Data is split to be stored in a plurality of banks. The pipeline 110 does not store data in a register but stores the data in the memory 120. A register is formed of a plurality of flip-flops. In other words, the pipeline 110 uses a memory instead of a register. If the pipeline 110 stores or manages data by using a register, the pipeline 110 requires a register for storing data that is transmitted between stages. Also, an operation of copying data to transmit the data between the stages has to be performed. However, if the pipeline 110 stores data in the memory 120, the pipeline 110 may transmit data to each of the stages by using an address of the memory 120 or an identification mark of the data.

The memory 120 may be a multi-bank static random access memory (SRAM) that includes a plurality of banks. A bank denotes a memory storage unit. In a multi-bank SRAM, data may be read or written in units of banks.

For example, a bank may include one read port and one write port. In this case, stages included in the pipeline 110 may only execute one read access and one write access with respect to the same bank. In other words, different stages may not read two or more pieces of data from the same bank. Also, different stages may not write two or more pieces of data to the same bank. A read port and a write port operate independently. Thus, in order to read or write two or more pieces of data from or to the same bank simultaneously, an additional bank may be assigned, and data may be stored in the additional bank. One of the two read operations may be performed by reading the bank in which data is stored, and the other is performed by reading the data stored in the additional bank.

Alternatively, a bank may include R read ports and W write ports. In this case, stages may execute R read accesses and W write accesses with respect to a single bank. That is, the stages may not simultaneously read R or more pieces of data from the same bank. Also, the stages may not simultaneously write W or more pieces of data to the same bank. A read port and a write port operate independently.

The pipeline 110 performs reading or writing by using an address of the memory 120. The pipeline 110 reads data stored at the address of the memory 120 or writes data to the memory 120.

Hereinafter, the description will focus on a multi-bank SRAM that includes one read port and one write port.

When different stages of the pipeline 110 perform reading or writing with respect to the same bank, the different stages of the pipeline 110 perform read or write operation, by using a plurality of different banks. In other words, when different stages of the pipeline 110 perform reading or writing on the same bank, the different stages of the pipeline 110 are not able to simultaneously read or write data from or to the same bank, and thus perform reading or writing by using an additional bank. When different stages of the pipeline 110 simultaneously perform two write operations to the same bank, the different stages of the pipeline 110 write data to an assigned additional bank and the same bank. The additional bank refers to an arbitrary bank that is different from the same bank. In detail, the different stages may write any one piece of write data to the memory 120 of an address of a previous bank, and write another piece of write data to a memory 120 at a new address of the assigned additional bank. Accordingly, the different stages may write two pieces of write data to different banks of the memory 120.

When different stages of the pipeline 110 simultaneously perform two read operations on the same bank, one of the different stages reads data stored in a previous bank, and the other of the stages reads data stored in an additional bank. In other words, as a bank, which the stages access, is fixed, any one piece of data is stored in the additional bank in advance in order to prevent the different stages from simultaneously performing two read operations on the same bank. For example, when first and second stages perform reading of data stored in the same bank, the first stage reads data stored at a previous address, and the second stage reads data stored at a new address.

Hereinafter, description will focus on a multi-bank SRAM that includes R read ports and W write ports.

Different stages of the pipeline 110 may simultaneously perform R or less read operations or W or less write operations with respect to the same bank. That is, as a multi-bank SRAM includes R read ports and W write ports, R or less read operations or W or less write operations with respect to the same bank may be simultaneously processed.

When different stages of the pipeline 110 simultaneously perform more than W write operations to the same bank, the different stages simultaneously perform the more than W write operations by using additional banks that are assigned based on the number of write operations that exceed W. The different stages write data about the W write operations to the same bank, and data about the rest of the write operations that exceed W, to additional banks.

For example, if W or less write operations are performed with respect to a bank, an additional bank is not assigned. If write operations that exceed W and are equal to or less than 2W are simultaneously performed, one additional bank is assigned to store data. Also, if write operations that exceed 2W and are equal to or less than 3W are simultaneously performed, two additional banks are assigned to store data. Accordingly, the stages may record data to previously assigned additional banks.

When different stages of the pipeline 110 simultaneously perform read operations that exceed R, with respect to the same bank, the different stages perform read operations that exceed R, which are stored in the assigned additional banks. The additional banks store data the rest of the read operations that exceeds R. For example, if the different stages perform R or less read operations, only one bank is used, and if the different stages perform read operations that exceed R and are equal to or less than 2R, one additional bank is used. Also, if the different stages perform read operations that exceed 2R and are equal to or less than 3R, two additional banks are used.

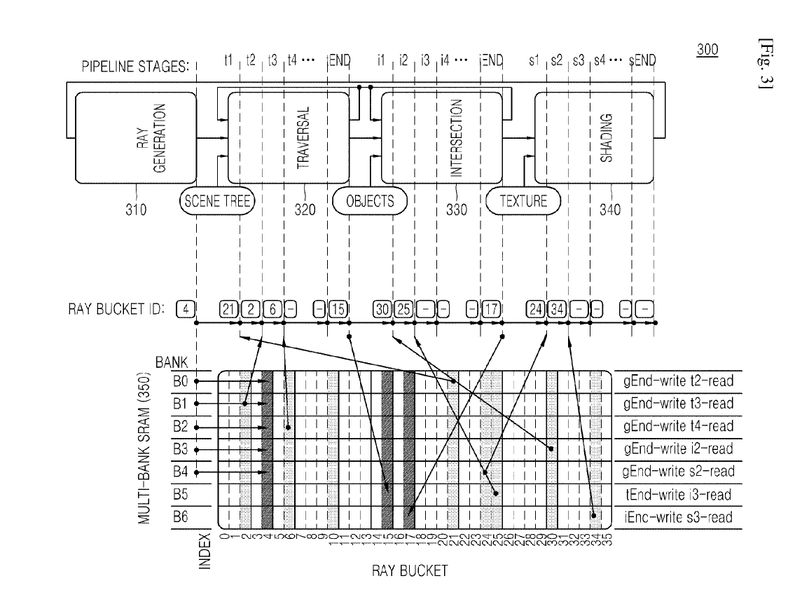

FIG. 2 is a detailed view illustrating the data processing apparatus of FIG. 1. Referring to FIG. 2, the pipeline 110 includes first through fifth stages 111 through 115. While the pipeline 110 including only the five, first through fifth stages 111 through 115 is illustrated in FIG. 2 for the sake of description, the number of stages is not limited to five. A stage may output an address or an ID of data to a next stage.

A memory 120 includes banks 0 through 5. Although the memory 120 is illustrated as being divided into six banks in FIG. 2 for the sake of description, the number of banks is not limited to six. Also, each bank is divided into a plurality of areas. In FIG. 2, each bank is illustrated as being divided into fourteen areas.

The banks 0 through 5 are independent from one another. For example, the first through fifth stages 111 through 115 may simultaneously write data to bank 1 and bank 3 or may simultaneously read data stored in bank 2 and bank 5. A bank that the first through fifth stages 111 through 115 access may be fixed.

A piece of data may be stored in a plurality of banks. In other words, data may be split, and split pieces of data may be stored in different banks. For example, one piece of data that is split and stored is illustrated in a hatched portion of FIG. 2. In other words, one piece of data is split into areas of Index 1 of banks 0 through 3 to be stored.

The first through fifth stages 111 and 115 access data by using an address of the memory 120. An address includes a bank number and an index. The number of a bank is from 0 to 5, and an index is from 0 to 13. The first through fifth stages 111 through 115 may access a fixed bank, and just an index that is accessed the first through fifth stages 111 through 115 may be different. For example, the first stage 111 may read data stored at an address (bank 2, index 5), and may read data stored at an address (bank 2, index 8) in a next cycle.

The first through fifth stages 111 through 115 each independently performs a calculation. Accordingly, the first through fifth stages 111 through 115 each independently access the memory 120. As reading and writing with respect to the banks included in the memory 120 are restricted according to characteristics of the banks, the first through fifth stages 111 through 115 may read or write data by using additional banks.

FIG. 3 is a view for explaining a ray tracing core 300 according to an embodiment of the present invention. The ray tracing core 300 is an example of the data processing apparatus 100 illustrated in FIGS. 1 and 2. Thus, any description that is omitted below but already provided with reference to the data processing apparatus 100 also applies to the ray tracing core 300 of FIG. 3.

A ray bucket ID (or an ID of a ray) is an identification mark of a ray that is being processed in each stage. A ray bucket ID may correspond to a multi-bank SRAM 350. In other words, ray data having a ray bucket ID of 21 may be stored in banks B0 through B6 corresponding to Index 21 of the multi-bank SRAM 350.

The ray tracing core 300 includes a ray generation unit 310, a traversal (TRV) unit 320, an intersection (IST) unit 330, a shading unit 340, and the multi-bank SRAM 350. The ray generation unit 310, the TRV unit 320, the IST unit 330, and the shading unit 340 of the ray tracing core 300 correspond to the pipeline 110 of FIG. 1. The ray generation unit 310, the TRV unit 320, the IST unit 330, and the shading unit 340 each independently performs a calculation, and accesses the multi-bank SRAM 350 to process data.

The ray tracing core 300 stores ray data in the multi-bank SRAM 350, and may transmit the ray data between the units 310 through 340 by using an address of the multi-bank SRAM 350 or a ray ID. The ray tracing core 300 stores ray data needed in a ray tracing operation, in the multi-bank SRAM 350. In other words, instead of transmitting ray data to each stage by using a register, the ray tracing core 300 transmits an address of ray data or a ray ID to each stage by using data stored in a memory. Accordingly, the units included in the ray tracing core 300 access ray data by using an address of the multi-bank SRAM 350 or a ray ID.

The ray generation unit 310, TRV unit 320, the IST unit 330, and the shading unit 340 may each include a plurality of stages. For example, the TRV unit 320 may include stages t1 through tEnd, and the IST unit 330 may include stages i1 through iEnd, and the shading unit 340 may include stages s1 through sEnd.

The multi-bank SRAM 350 includes a plurality of banks B0 through B6. The banks BO through B6 include storage space divided into Index 0 through Index 35.

The multi-bank SRAM 350 stores ray data. Ray data is split into a plurality of banks to be stored. For example, ray data generated by using the ray generation unit 310 is divided into five pieces, and the five pieces of ray data are respectively stored in Index 4 of each of the bank 0 B0 through bank 4 B4.

In FIG. 3, an arrow denotes an address required by each stage. A direction of the arrow denotes a read operation or a write operation. The direction of the arrow indicating the memory 120 denotes a write operation, and the arrow indicating an opposite direction thereto denotes a read operation. For example, the stage t2 of the TRV unit 320 reads data stored in Index 21 of bank 0. Alternatively, the stage iEnd of the IST unit 330 writes data to Index 17 of bank 6.

The ray tracing core 300 traces intersection points between generated rays and objects located in three-dimensional space, and determines color values of pixels that constitute an image. In other words, the ray tracing core 300 searches for an intersection point between rays and objects, and generates secondary ray data based on characteristics of an object at an intersection point, and determines a color value of the intersection point. The ray tracing core 300 stores the ray data in the multi-bank memory 350 and updates the same.

The ray generation unit 310 generates primary ray data and secondary ray data. The ray generation unit 310 generates primary ray data from a view point. The ray generation unit 310 generates secondary ray data from an intersection point between the primary ray and an object. The ray generation unit 310 may generate a reflection ray, a refraction ray, or a shadow ray from the intersection point between the primary ray data and the object.

The ray generation unit 310 stores the primary ray data or the secondary ray data in the multi-bank SRAM 350. The primary ray data or the secondary ray data is split and stored in the multi-bank SRAM 350. The ray generation unit 310 transmits an address at which the ray data is stored or a ray ID, to the TRV unit 320. The ray ID is information whereby a ray is identified. A ray ID may be marked as a number or a letter. The TRV unit 320 receives the address at which the generated ray data is stored or the ray ID, from the ray generation unit 310. For example, regarding a primary ray, the TRV unit 320 may receive an address at which data about a viewpoint and a direction of a ray is stored. Also, regarding a secondary ray, the TRV unit 320 may receive an address at which data about a starting point and a direction of a secondary ray is stored. A starting point of a secondary ray denotes a point of a primitive which a primary ray has hit. A viewpoint or a starting point may be expressed using coordinates, and a direction may be expressed using vector notation.

The TRV unit 320 searches for an object or a leaf node that is hit by a ray, by using data stored in the multi-bank SRAM 350. The TRV unit 320 traverses an acceleration structure to output data about the object or the leaf node that is hit by a ray. The output data is stored in the multi-bank SRAM 350. In detail, the TRV unit 320 writes which object or leaf node is hit by the ray, by accessing the multi-bank SRAM 350. In other words, after traversing an acceleration structure, the TRV unit 320 updates ray data stored in the multi-bank SRAM 350.

The TRV unit 320 may output an address at which ray data is stored or an ID of a ray, to the IST unit 330. The IST unit 330 obtains ray data by accessing the multi-bank SRAM 350 by using the address or the ID of the ray received from the TRV unit 320.

The IST unit 330 obtains an object that is hit by a ray, from the data stored in the multi-bank SRAM 350. The IST unit 30 receives an address at which ray data is stored, from the TRV unit 320, and obtains an object hit by a ray, from data stored at the received address.

The IST unit 330 conducts an intersection test on an intersection point between a ray and a primitive to output data about a primitive hit by a ray and an intersection point. The output data is stored in the multi-bank SRAM 350. In other words, the IST unit 330 updates ray data stored in the multi-bank SRAM 350.

The IST unit 330 may output an address at which ray data is stored or a ray ID, to the shading unit 340. The shading unit 340 obtains ray data by accessing the multi-bank SRAM 350 by using the address or the ray ID received from the IST unit 330.

The shading unit 340 determines a color value of a pixel based on information about an intersection point that is obtained by accessing the multi-bank SRAM 350 or characteristics of a material of the intersection point. The shading unit 340 determines a color value of a pixel in consideration of basic colors of the material of the intersection point and effects due to a light source.

As described above, the ray tracing core 300 may transmit ray data by using an address of ray data or a ray ID. Accordingly, the ray tracing core 300 may omit an unnecessary operation of copying the entire ray data. Also, the ray tracing core 300 may split ray data and store the same in the multi-core SRAM 530 so as to access only some necessary pieces of data from among ray data or read or write only some pieces of data.

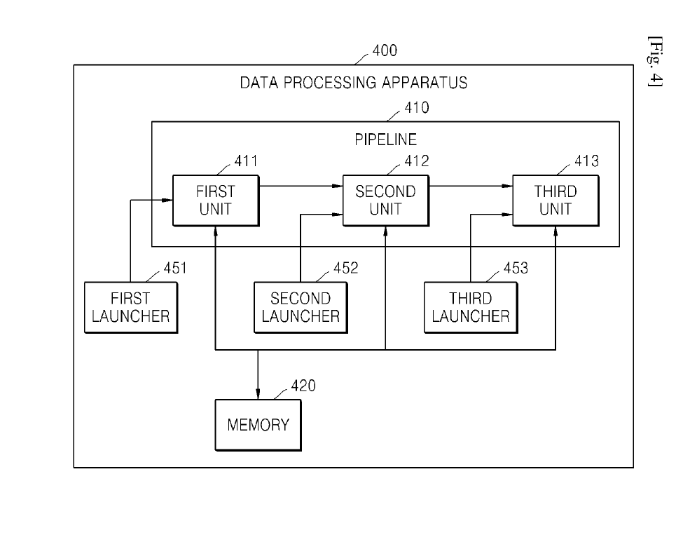

FIG. 4 is a view for explaining a data processing apparatus 400 according to an embodiment of the present invention. The data processing apparatus 400 of FIG. 4 is a modified example of the data processing apparatus 100. Thus, any description omitted below but already provided above with reference to the data processing apparatus 100 of FIG. 1 also applies to the data processing apparatus 400 of FIG. 4.

Referring to FIG. 4, the data processing apparatus 400 further includes first through third launchers 451 through 453. Also, the pipeline 410 includes first through third units 411 through 413. The first through third units 411 through 413 each include at least one stage.

The first through third launchers 451 through 453 schedule data to be processed by the first through third units 411 through 413 in a next cycle. The first through third launchers 451 through 453 may determine an order of data to be processed by the first through third units 411 through 413 in a next cycle, and may schedule data to the first through third units 411 through 413 according to the determined order.

The first through third launchers 451 through 453 provide only an address of data to be processed by the first through third units 411 through 413 or a ray ID. The entire data is stored in a memory 420.

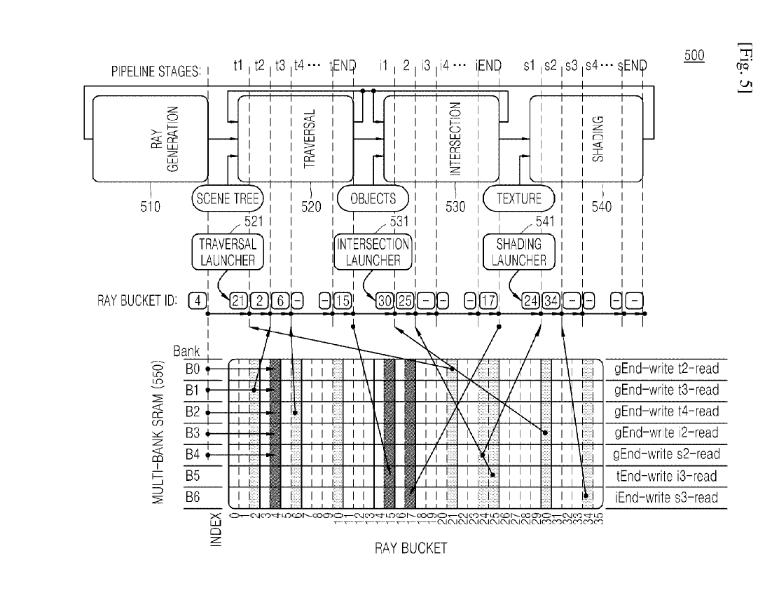

FIG. 5 is a view for explaining a ray tracing core 500 according to an embodiment of the present invention. The ray tracing core 500 is an example of the data processing apparatus 100 or 400 illustrated in FIGS. 1 and 2 or FIG. 4. Thus, any description omitted below but provided with respect to the data processing apparatus 100 or 400 also applies to the ray tracing core 500 of FIG. 5.

The ray tracing core 500 further includes launchers 521 through 541 including a TRV launcher 521, an IST launcher 531, and a shading launcher 541. The TRV launcher 521 schedules ray data to be processed by a TRV unit 520; the IST launcher 531 schedules ray data to be processed by an IST unit 530; and the shading unit 541 schedules ray data to be processed by a shading unit 540. The launchers 521 through 541 provides the units 510 through 540 with information about which part of the multi-bank SRAM 550 stores ray data to be processed in a next cycle. For example, the launchers 521 through 541 provide a ray bucket ID to the units 510 through 540, and the units 510 through 540 read ray data stored at an address of the multi-bank SRAM 550 corresponding to the ray bucket ID or write ray data.

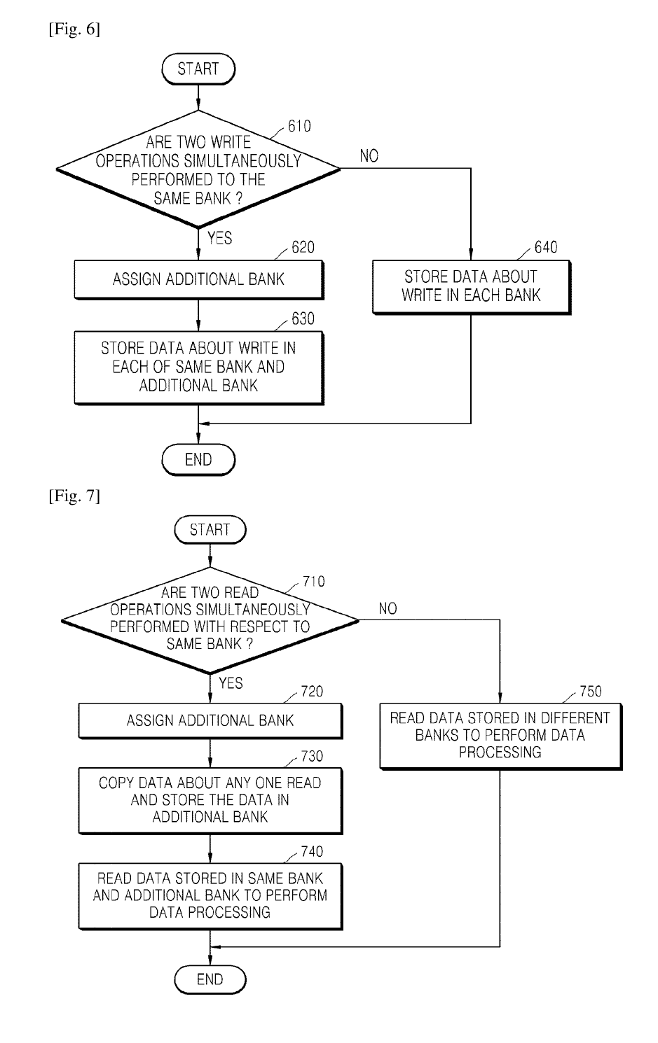

FIG. 6 is a flowchart illustrating a data processing method according to an embodiment of the present invention. FIG. 6 illustrates operations performed by using the data processing apparatus 100 of FIG. 1. Thus, any description omitted below but provided with respect to the data processing apparatus 100 also applies to the data processing method of FIG. 6.

The data processing method of FIG. 6 relates to a method of storing data in a memory when the memory includes one write port.

In operation 610, the data processing apparatus 100 determines whether two write operations are simultaneously performed to the same bank. Whether the same bank is being accessed by stages may be determined by using the data processing method of the stages. As a bank, which the stages access, is fixed, the data processing apparatus 100 may determine how many stages access the same bank based on information about which stage accesses which bank. If two pieces of data are simultaneously written to the same bank, the method proceeds to operation 620, and otherwise, the method proceeds to operation 640.

In operation 620, the data processing apparatus 100 assigns an additional bank.

In operation 630, the data processing apparatus 100 stores data about write operations in each of the same bank and the additional bank. In other words, the data processing apparatus 100 stores one piece of data in an initially designated bank, and the other piece of data in a newly assigned additional bank.

In operation 640, the data processing apparatus 100 stores data about write operations, in each bank. The data processing apparatus 100 may simultaneously store data in different banks, and thus, stores two pieces of data in different banks. FIG. 7 is a flowchart illustrating a data processing method according to an embodiment of the present invention. FIG. 7 illustrates operations performed by using the data processing apparatus 100 of FIG. 1. Thus, any description omitted below but provided above with reference to the data processing apparatus 100 also applies to the data processing method of FIG. 7.

The data processing method of FIG. 7 relates to a data reading method when a memory includes one read port.

In operation 710, the data processing apparatus 100 determines whether two read operations are simultaneously performed on the same bank. If two pieces of data are to be read from the same bank, the method proceeds to operation 720. Otherwise, the method proceeds to operation 750.

In operation 720, the data processing apparatus 100 assigns an additional bank.

In operation 730, the data processing apparatus 100 copies data about any one of the read operations and stores the same in the additional bank.

In operation 740, the data processing apparatus 100 reads the data stored in the same bank and the additional bank to perform data processing on the data.

In operation 750, the data processing apparatus 100 reads data stored in different banks to perform data processing on the data.

FIG. 8 is a flowchart illustrating a data processing method according to another embodiment of the present invention. FIG. 8 illustrates operations performed by using the data processing apparatus 100 of FIG. 1. Thus, any description omitted below but provided above with reference to the data processing apparatus 100 also applies to the data processing method of FIG. 8.

The data processing method of FIG. 8 relates to a method of storing data in a memory when the memory includes W write ports.

In operation 810, the data processing apparatus 100 determines whether write operations that exceed W are performed with respect to the same bank. If data of a number of write operations exceeding W is simultaneously written to the same bank, the method proceeds to operation 820. Otherwise the method proceeds to operation 850.

In operation 820, the data processing apparatus 100 assigns additional banks according to the number of write operations. Every time when the number of write operations exceeds W, the data processing apparatus 100 assigns an additional bank.

In operation 830, the data processing apparatus 100 stores data about W write operations in the same bank. In other words, the data processing apparatus 100 stores W pieces of data in an initially designated bank.

In operation 840, the data processing apparatus 100 stores data about the rest of write operations, in additional banks. In other words, the data processing apparatus 100 stores the rest of data in banks that are different from the initially designated bank.

In operation 850, the data processing apparatus 100 stores data about write operations in a designated bank. As the number of data does not exceed W, the data processing apparatus 100 may simultaneously store W pieces of data in the designated bank. The data processing apparatus 100 may simultaneously store W or less pieces of data in a bank, and thus, W or less pieces of data is stored in a bank without assigning an additional bank.

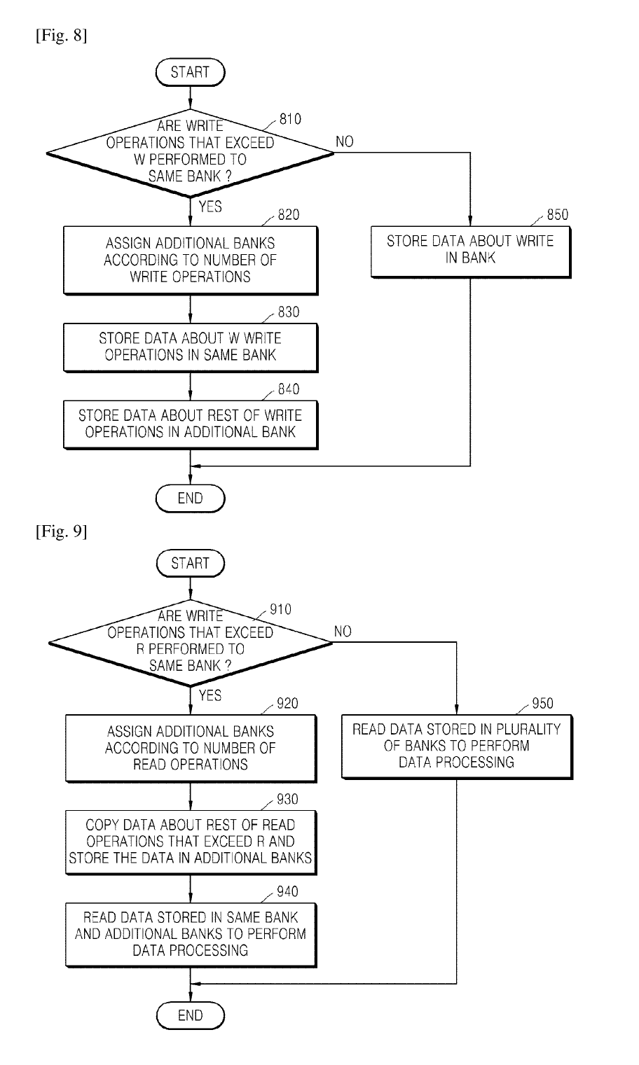

FIG. 9 is a flowchart illustrating a data processing method according to another embodiment of the present invention. FIG. 9 illustrates operations performed by using the data processing apparatus 100 of FIG. 1. Thus, any description omitted below but provided above with reference to the data processing apparatus 100 also applies to the data processing method of FIG. 9.

The data processing method of FIG. 9 relates to a data reading method when a memory includes W write ports.

In operation 910, the data processing apparatus 100 determines whether read operations that exceed R are performed on the same bank. If data that exceeds R is to be read from the same bank, the method proceeds to operation 920. Otherwise, the method proceeds to operation 950.

In operation 920, the data processing apparatus 100 assigns an additional bank according to the number of read operations. Every time when the number of read operations exceeds R, the data processing apparatus 100 assigns an additional bank.

In operation 930, the data processing apparatus 100 copies data about the rest of read operations that exceed R and stores the same, in additional banks.

In operation 940, the data processing apparatus 100 reads data stored in the same bank and the additional banks to perform data processing.

In operation 950, the data processing apparatus 100 reads data stored in a plurality of banks to perform data processing thereon. The data processing apparatus 100 may simultaneously read R or less pieces of data from a single bank, and thus, the data processing apparatus 100 reads R or less pieces of data from the single bank without assigning an additional bank.

1. A data processing apparatus comprising:
a pipeline including a plurality of stages; and
a memory that stores data that is processed in the pipeline.

2. The data processing apparatus of claim 1, wherein the memory comprises a multi-bank static random access memory (SRAM) that includes a plurality of banks, and the data is split and stored in the plurality of banks.

3. The data processing apparatus of claim 2, wherein each of the plurality of banks comprises one read port and one write port, and
when different stages of the pipeline simultaneously perform read operations or write operations with respect to a same bank, data about the read operations or the write operations is stored in a plurality of different banks.

4. The data processing apparatus of claim 3, wherein when the different stages of the pipeline simultaneously perform two write operations to the same bank, the different stages of the pipeline write one of two pieces of write data to the same bank and the other piece to an additional bank.

5. The data processing apparatus of claim 3, wherein when the different stages of the pipeline simultaneously perform two read operations with respect to the same bank, the different stages of the pipeline read data stored in the same bank and an additional bank.

6. The data processing apparatus of claim 2, wherein each of the plurality of banks includes R read ports and W write ports, and
different stages of the pipeline simultaneously perform R or less read operations or W or less write operations with respect to the same bank.

7. The data processing apparatus of claim 6, wherein when the different stages of the pipeline simultaneously perform write operations that exceed W, to the same bank, the different stages of the pipeline perform W write operations to the same bank, and perform the rest of the write operations to additional banks.

8. The data processing apparatus of claim 6, wherein when the different stages of the pipeline simultaneously perform read operations that exceed R with respect to the same bank, the different stages of the pipeline read R pieces of data stored in the same bank and the rest of data that exceed R, stored in the additional banks.

9. The data processing apparatus of claim 1, wherein the pipeline performs ray tracing by using ray data, and
the memory stores the ray data by splitting the ray data.

10. The data processing apparatus of claim 1, further comprising a plurality of launchers that schedule data to be processed by the different stages.

11. A data processing method performed by using a pipeline including a plurality of stages, the data processing method comprising:
storing data processed in the pipeline, in a memory; and
processing data by using the data stored in the memory.

12. The data processing method of claim 11, wherein the memory is a multi-bank static random access memory (SRAM) including a plurality of banks, and the data is split and stored in the plurality of banks.

13. The data processing method of claim 12, wherein each of the plurality of banks comprises one read port and one write port, and
in the storing of the data, when different stages of the pipeline simultaneously perform read operations or write operations with respect to the same bank, data about the read operations or the write operations is assigned to a plurality of different banks.

14. The data processing method of claim 13, wherein the storing comprises:
assigning an additional bank when the different stages of the pipeline simultaneously perform two write operations to the same bank; and
storing data about one of the two write operations in the same bank and data about the other write operation to the additional bank.

15. The data processing method of claim 13, wherein the storing comprises:
assigning an additional bank when the different stages of the pipeline simultaneously perform two read operations with respect to the same bank; and
copying data about one of the read operations and storing the data in the additional bank.

16. The data processing method of claim 12, wherein the multi-bank SRAM comprises R read ports and W write ports, and
in the storing of data, R or less read operations or W or less write operations with respect to the same bank that are simultaneously performed by using different stages of the pipeline are stored in the same bank.

17. The data processing method of claim 16, the storing comprises:
when the different stages of the pipeline simultaneously perform write operations that exceed W to the same bank, assigning additional banks according to the number of the write operations that exceed W; and
writing data about W write operations to the same bank, and data about the rest of the write operations to the additional banks.

18. The data processing method of claim 16, wherein the storing of data comprises:
when the different stages of the pipeline simultaneously perform read operations that exceed R, assigning additional banks according to the number of read operations that exceed R; and
copying data about the rest of read operations that exceed R and storing the data in the additional banks.

19. The data processing method of claim 11, wherein the pipeline performs ray tracing by using ray data, and
the memory stores the ray data by splitting the ray data.

20. The data processing method of claim 11, further comprising scheduling data to be processed by the stages,
wherein the processing of data comprises processing data according to the scheduling.

21. A recording medium having embodied thereon a program for executing the method of claim 11.
